(19) United States
(12) Patent Application Publication
(10) Pub. No.: US 2018/0332837 A1
(43) Pub. Date: Nov. 22, 2018

(54) Hidden Swivel is the ability to hide the swivel/latch/knot inside any manufactured lure using a quick release pin

(71) Applicant: Gary Morrow, Monument, CO (US)

(72) Inventor: Gary Morrow, Monument, CO (US)

(21) Appl. No.: 15/601,665

(22) Filed: May 22, 2017

(51) Int. Cl. A01K 91/04; A01K 85/12; F16B 1/00; F16B 21/12

(52) U.S. Cl. CPC A01K 91/04; A01K 85/12; F16B 2021/14; F16B 21/12; F16B 2001/0035; F16B 1/00

(57) ABSTRACT

The Hidden Swivel hides the essential swivel/latch/knot inside the fishing lure with a quick release pin. This allows anglers to fish with a clean, strong set up that is easy to change out to different lures.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

For decades avid anglers have been frustrated with making a more natural presentation to the fish by trying to hide the essential latching and swivel mechanism as well as the fishing line knot itself. Offering the ability to not only hide the swivel and knot, but to allow quick release to change to different lures is very appealing to many anglers.* (*)=reference

### BRIEF SUMMARY OF THE INVENTION

The primary objective is to hide the essential swivel/latch knot to make the lure more natural looking to the fish. Another objective is to allow anglers to quickly and easily change the line with swivel to another lure. The quick release pin makes it quick and easy to switch to another lure.

### BRIEF DESCRIPTION OF THE VIEWS OF THE DRAWINGS

FIG. 1 is a standard barrel swivel tested at 120 lbs. (Can use other swivels.) The fishing line knot is tied at the top of the swivel.

FIG. 2 is the stainless steel “T” sleeve (optional) with attached magnet strong enough to hold pin.

FIG. 3 is a stainless steel pin with nail type head.

FIG. 4 is strong, small magnet to lock pin.

FIG. 5 shows the flared top of the stainless steel sleeve that allows for a smooth, flat surface that will not cut or fray the fishing line.

FIG. 6 is top view of lure with hidden swivel mechanism inside.

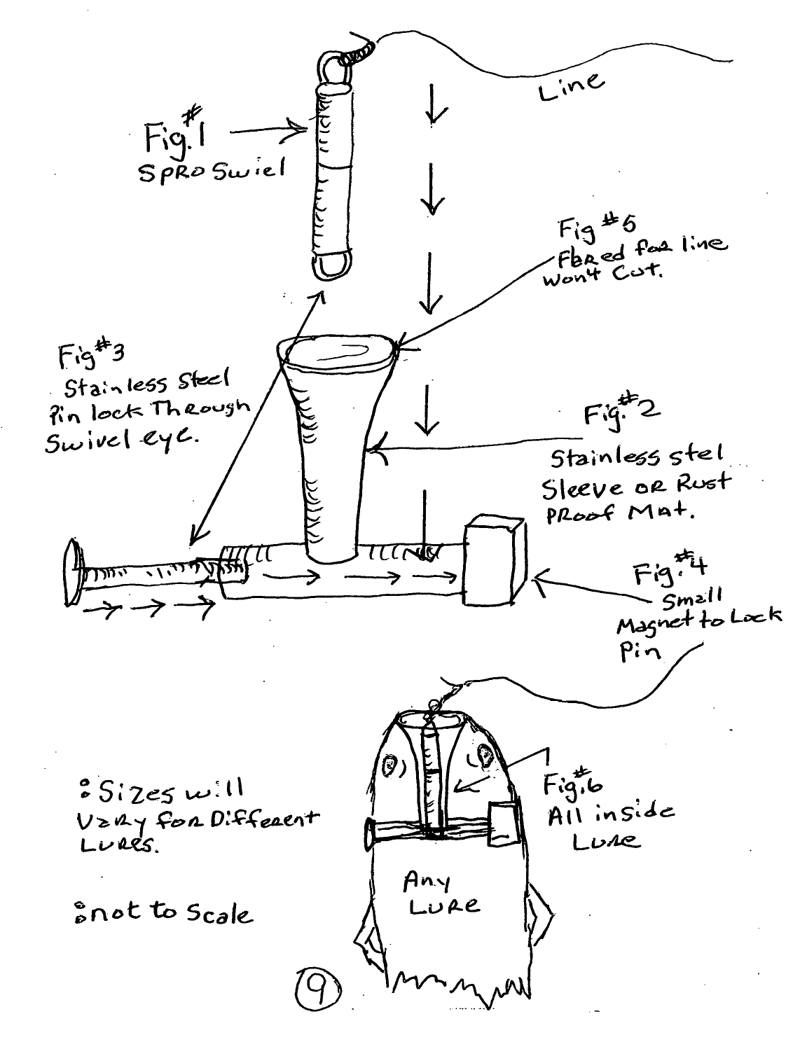

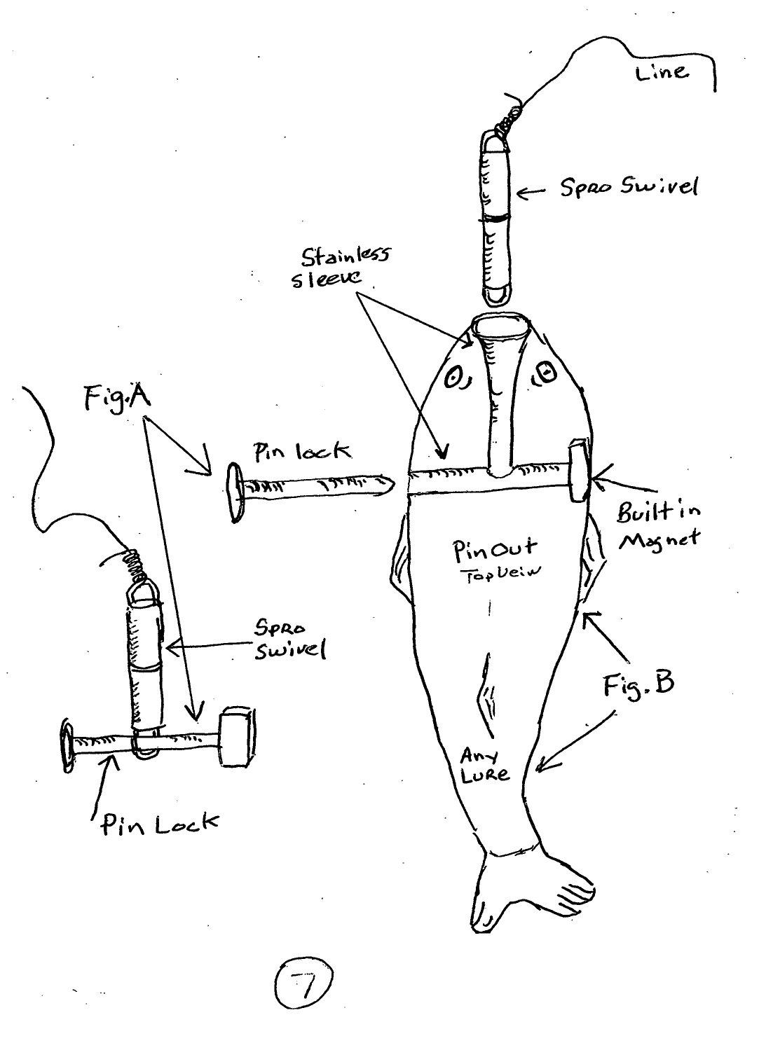

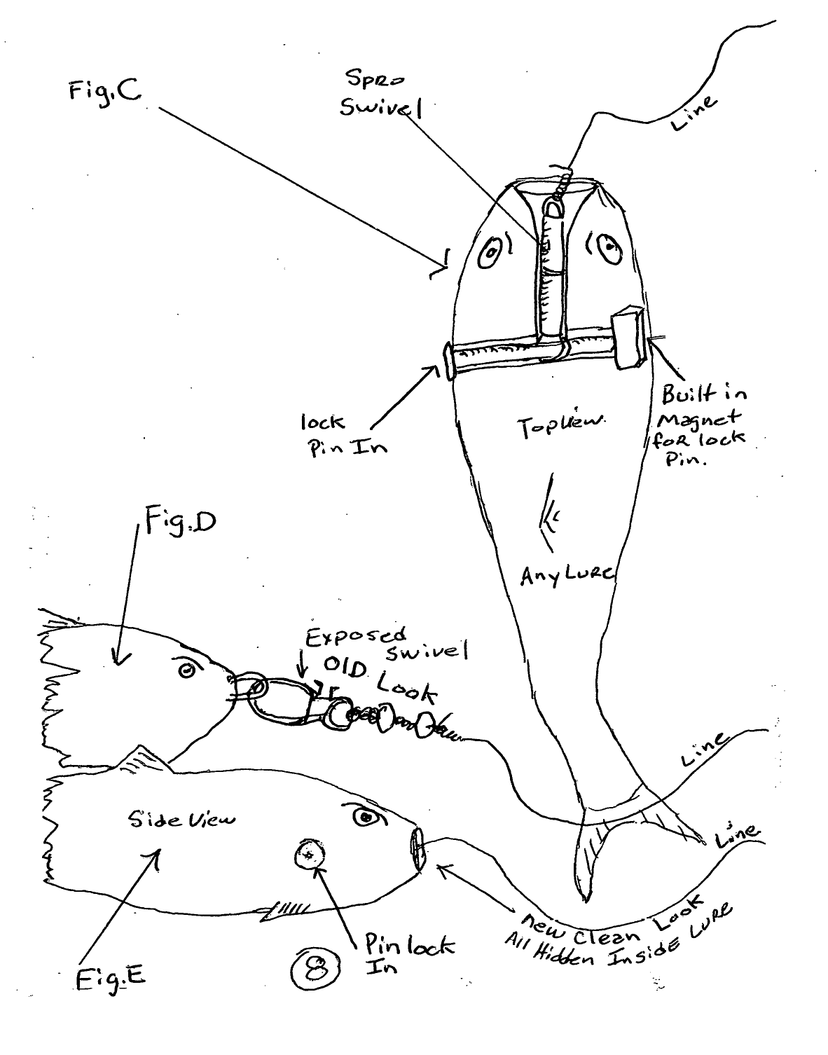

Fig. A shows the stainless steel pin going through barrel swivel to attach to magnet inside the sleeve within the lure. (Other quick release pin options doable.)

Fig. B top view of lure with the barrel swivel outside the lure (not attached).

Fig. C shows top view of lure with the barrel swivel inside the lure (attached) with the stainless sleeve pin inside the stainless steel sleeve (optional).

Fig. D shows the old look of a lure and how it is not attractive to fish looking to bite the lure.

Fig. E shows the new “clean” look of the lure with the hidden swivel inside the lure that works the same, but much cleaner. (Very attractive to fish.)

### DETAILED DESCRIPTION OF THE INVENTION

Devised a method to hide the swivel/latch/knot inside the lure. The hidden swivel begins with the strong stainless steel “T” sleeve with a pin to magnet technology to hold the swivel INSIDE any fishing lure that has manufactured their lure around this sleeve. Other rust proof materials i.e. plastic, copper, brass can be used. If the lure is solid material in the front, manufacture may mold around sleeve or drill through solid material. (Manufactures choice.) This allows a smooth, simple attachment for the angler allowing the swivel/latch/knot to be hidden nicely inside the lure. The smooth trumpet style top to the sleeve allows the fishing line to move easily without being cut or frayed by any sharp edges. The ideal swivel to use is a barrel swivel that is tested at 120 lbs. (Other swivels may be used.) The hidden swivel can be manufactured in both freshwater lures and saltwater lures.

The pin can be easily removed by the “nail” type head outside the side of the lure. Just pinch the head with your fingers/nails and it releases from the magnet to allow the swivel and knot to be removed together and put into another lure. The magnet can either be a part of the sleeve or can be molded into a solid lure that opted to be drilled out. Each lure would be manufactured with the correct sized sleeve and pin combination. Every hidden swivel lure will allow anglers to fish with a clean set-up.

Hook, Line and Sinker: The Complete Angler's guide to Terminal Tackle “To swivel or not to swivel” talks about anglers not wanting to use the swivel because it detours the fish. Anglers agree the swivel is necessary! Field & Stream: February 2000-Page 82

“Critical Connections” talks about the need for swivels, but how many anglers want it to be clean and just tie the line to the lure. This causes problems and you have to retie to every lure you use.

1. The Hidden Swivel hides all connections (swivel/latch/knot) from fish by being inside the lure for a clean fishing experience. The quick release pin allows anglers a quick, easy way to switch to another lure.
